(19) United States
(12) Patent Application Publication
(10) Pub. No.: US 2005/0002767 A1
(43) Pub. Date: Jan. 6, 2005

(54) Lift and trailer for watercraft

(76) Inventor: Roland R. Oosterhouse, Traverse City, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/613,793

(22) Filed: Jul. 3, 2003

(51) Int. Cl. B60P 1/64

(52) U.S. Cl. 414/498

(57) ABSTRACT

A dolly and trailer provide for transport and/or storage of watercraft. The dolly includes a lift and a winch that can be utilized to shift a watercraft from the trailer to the dolly. The trailer includes watercraft supports that are retractable to permit the trailer to be used as a utility trailer. Alternately, the supports can be positioned upwardly to support a watercraft on the trailer. A watercraft on the dolly can be positioned at an upper position for transport to the trailer or vice versa, and the dolly and the trailer each include winches to permit a single person to readily transfer the watercraft from the dolly to the trailer or vice versa.

### BACKGROUND OF THE INVENTION

The present invention relates to a lift and trailer for watercraft, although it is not limited to only watercraft uses, as discussed below.

Various trailers and the like have been developed for transporting and launching boats and personal watercraft. However, known trailers are generally specifically configured to support and transport only a single watercraft, such that the trailer is generally not usable for other purposes. Various support stands and the like have been developed for supporting boats and other watercraft during storage. However, such stands may not provide for convenient manual movement of the watercraft, and also may not provide height adjustment. Still further, it may be difficult to load a watercraft or boat onto known supports due to the frictional engagement between the support and the watercraft hull. Further, such devices are often complicated to use and/or expensive to manufacture, making them inconvenient to use or cost-prohibitive to purchase.

Accordingly, apparatuses are desired solving the aforementioned problems and having the aforementioned advantages.

### SUMMARY OF THE INVENTION

One aspect of the present invention is a dolly for supporting watercraft and the like. The dolly includes a base frame having a plurality of wheels for movably supporting the base frame on a surface. A pair of elongated parallel bunks are fixed to the base frame, and includes upper surfaces adapted to support a watercraft on the dolly in a lowered position. A support frame is vertically movably mounted to the base frame, and has a plurality of spaced-apart rollers configured to movably support a watercraft. A lift is operably interconnected with the base frame and the support frame. The lift is configured to move the support frame from a lower position wherein the rollers are at least about as low as the upper surfaces of the bunks, and a raised position wherein the rollers are substantially above the upper surfaces of the bunks.

Another aspect of the present invention is a trailer for transport of watercraft. The trailer includes a frame having at least a pair of wheels and a tongue adapted to secure the trailer to a motor vehicle for transport of the trailer. An enlarged horizontal main support surface is secured to the frame, the main support surface having a pair of elongated openings. The trailer further includes first and second elongated bunks that are movably interconnected with the frame for movement between raised and lowered positions. The first and second bunks define upper support surfaces that are positioned at about the same height as the main support surface when the bunks are in the lowered position. First and second linkages movably interconnect the bunks to the frame. The first and second linkages each include a link having a first end pivotably connected to the frame, and a second end pivotably connected to one of the bunks. The trailer further includes retainers that secure the bunks in the raised positions.

Another aspect of the present invention is a kit for supporting watercraft. The kit includes a dolly having a base frame with a plurality of wheels adapted to movably support the dolly on a surface. The dolly includes a support frame having a plurality of rollers movably mounted to the base frame for movement between raised and lowered positions. The kit also includes a trailer including a trailer frame and at least a pair of wheels to movably support the trailer on a surface. The trailer also includes an enlarged horizontal main support surface and a pair of elongated bunks defining upper support surfaces positioned above the main support surface. The rollers of the dolly are positioned at about the same height as the upper support surfaces of the bunks of the trailer when the support frame is in the raised position to facilitate transfer of a watercraft from the dolly onto the bunks of the trailer and vice versa.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a perspective view of a dolly according to one aspect of the present invention;

FIG. 2 is a perspective view of a trailer according to the present invention and the dolly of FIG. 1;

FIG. 3 is a fragmentary view of the trailer bunk taken along the line III-III; FIG. 2; and

FIG. 4 is a partially fragmentary elevational view illustrating the transverse of a watercraft between the trailer and the dolly.

### DETAILED DESCRIPTION OF PREFERRED EMBODIMENT

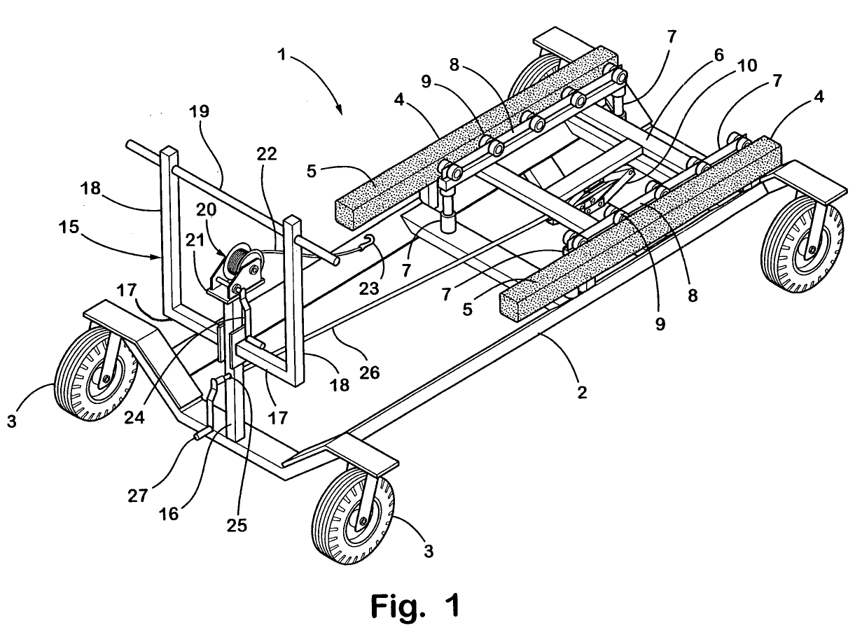

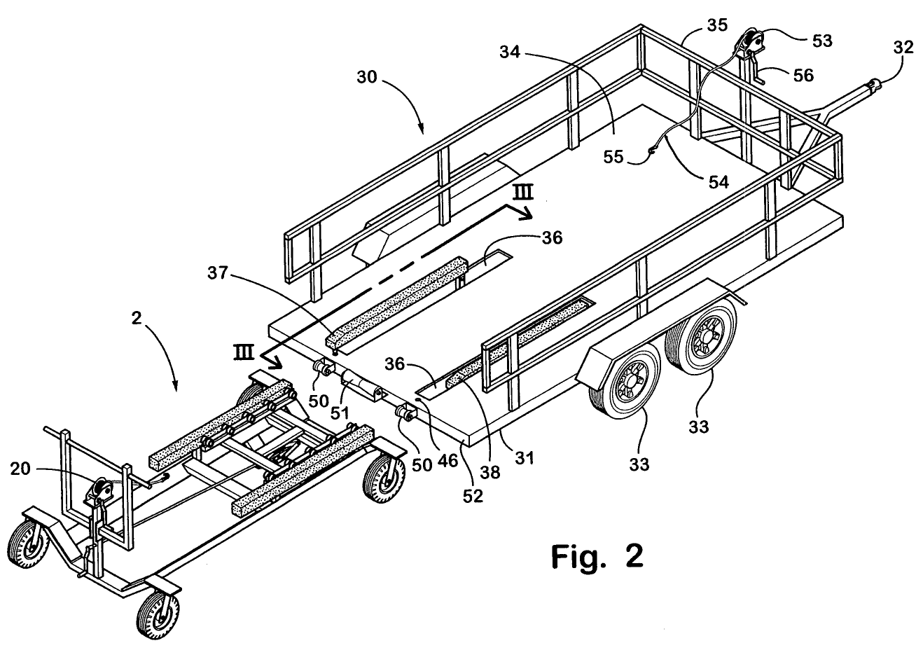

For purposes of description herein, the terms “upper,” “lower,” “right,” “left,” “rear,” “front,” “vertical,” “horizontal,” and derivatives thereof shall relate to the invention as oriented in FIGS. 1 and 2. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

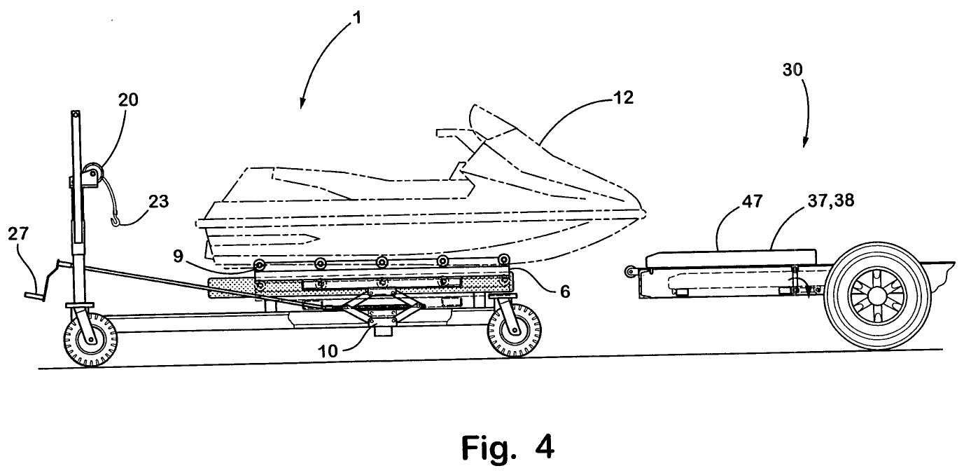

With reference to FIG. 1, the dolly 1 according to one aspect of the present invention includes a base frame 2 having a plurality of wheels 3 for movably supporting the base frame 2 on a surface. A pair of elongated bunks 4 are immovably fixed to the base frame 2, and include upper surfaces 5 adapted to support a watercraft on the dolly 1 in a lowered position. A support frame 6 is movably mounted to the base frame 2 via a plurality of linear guides 7 such that the support frame 6 can be moved vertically relative to the base frame 2. The support frame 6 includes a pair of elongated parallel structural members 8, to which a plurality of spaced apart rollers 9 are mounted for movably supporting a watercraft. A lift such as a scissors jack 10 is interconnected with the base frame 2 and the support frame 6. The scissors jack 10 is configured to move the support frame 6 from a lower position (e.g. FIG. 1) to a raised positioned (FIG. 4). In the lower position the rollers 9 are positioned below the upper surfaces 5 of the bunks 4, such that a watercraft 12 is supported on the upper surfaces 5 of the bunks 4. As the support frame 6 is raised, the rollers 9 contact the lower surface of the watercraft, and raise it off the bunks 4. Thus, rollers 9 permit the watercraft to be easily moved on and off the dolly 1 when the support frame 6 is raised, and the fixed bunks 4 securely support the watercraft when it is lowered.

The dolly 1 includes a structural winch/handle structure 15 that includes a first upright frame member 16, and a pair of horizontal frame members 17. Upright frame members 18 extend upwardly from the horizontal frame member 17, and supports a horizontal bar 19 to form a handle that facilitates movement of the dolly 1 by a user. A winch 20 is mounted to the upper end 21 of the first upright frame member 16, and includes a cable 22 and hook 23 that can be utilized to pull the watercraft onto the dolly 1 by rotation of handle 24. An elongated rod 26 is operably connected to the scissors jack 10. The elongated rod 26 passes through an opening 25 in the frame member 16, and a handle 27 is connected to the rod 26. Thus, a user can readily grasp the handle 27 to rotate the rod 26 and thereby actuate the scissors jack 10 to raise and the lower the support frame 6 and a watercraft positioned on the dolly 1.

With further reference to FIG. 2, another aspect of the present invention is a trailer 30 having a frame 31 with a tongue 32 for connection to a motor vehicle or the like. The trailer 30 includes wheels 33 for transport on a road surface or the like. An enlarged horizontal main support surface 34 is secured to the frame, and a fence like frame 35 extends around the perimeter of the trailer to ensure that items positioned on the main support surface 34 are not inadvertently dislodged therefrom. The main support surface 34 includes a pair of elongated parallel openings 36 therethrough that receive first and second bunks 37 and 38, respectively. The bunks 37 and 38 can be shifted upwardly as illustrated by the bunk 37 of FIG. 2, or can be retracted to a lowered position within the opening 36 as illustrated by the second bunk 38 of FIG. 2. When the bunks 37 and 38 are in the upper position, they can be utilized to support a watercraft 12 above the main support surface 34. Alternately, the bunks 37 and 38 can be shifted downwardly within the openings 36 to permit the trailer 30 to be utilized for transport of a wide variety of items. Thus, the trailer 30 can be readily reconfigured for use in transporting and/or storing a watercraft, or for virtually any other use.

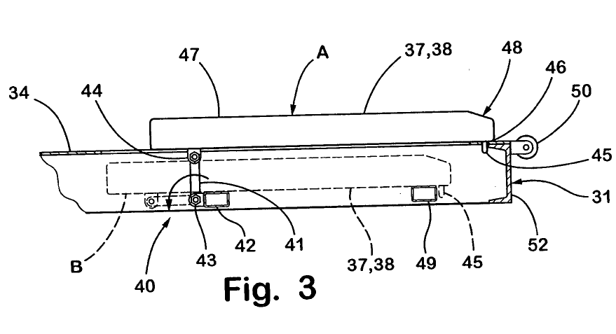

With further reference to FIG. 3, the bunks 37 and 38 are connected to the frame 31 by a linkage arrangement 40 that includes a link 41 that is pivotally connected to a horizontal frame member 42 at a pivot point 43. The upper end 44 of the link 41 is pivotally connected to the bunk 37 (or 38). A pin 45 may be selectively positioned in an opening 46 in the main support surface 34 to retain the bunk 37 or 38 in the upper position “A” (FIG. 3). Alternately, the bunks 37 and 38 can be shifted to the lower position “B” such that the upper surface 47 of the bunks 37 and 38 is below the main support surface 34. This is accomplished by lifting the rear end 48 of the bunk 37 or 38 to disengage the pin 45 from the opening 46. The bunk 37 or 38 is then moved forwardly, such that the link 41 rotates about the pivot point 43 until the bunk 37 or 38 is in the lower or retracted position B wherein the bunks 37 and/or 38 are supported on the horizontal frame members 42 and 49. The bunks 37 and 38 can be shifted from the lower position B to the upper position A by lifting the bunk upwardly and inserting the pin 45 into the opening 46. The pin 45 thereby retains the bunks 37 and 38 in the upper position. The bunks 37 and 38 can therefor be readily shifted between the upper position for supporting a watercraft, and the lower position to permit use of the trailer 30 for other purposes. In a preferred embodiment, the trailer includes outer rollers 50, and a large center roller 51 that are mounted to the rear edge 52 of the trailer frame 31 to assist in guiding and moving the watercraft onto the trailer 30.

With further reference to FIG. 4, in use the support frame 6 of dolly 1 can be raised to a height wherein the rollers 9 are at substantially the same height as the upper surfaces 47 of the bunks 37 and 38 to thereby facilitate transfer of the watercraft 12 from the dolly 1 to the trailer 30 and vice versa. The trailer 30 includes a winch 53 (see also FIG. 2) having a cable 54 and a hook 55 that can be retracted by rotation of handle 56. Thus, to transfer the watercraft 12 from the dolly 1 to the trailer 30, the watercraft 12 is first raised to about the same height as the bunks 37 and 38 on the trailer 30. The winch 53 can then be connected to the watercraft 12, and the watercraft 12 is pulled onto the trailer 30 by rotation of the handle 56 of winch 53. To remove the watercraft 12 from the trailer 30, the hook 23 of winch 20 on dolly 1 may be connected to the watercraft 12, and the watercraft 12 is then pulled from the trailer 30 to the dolly 1. When the watercraft 12 is on the dolly 1, the scissors jack 10 can be used to raise or lower the watercraft 12 as desired by rotation of handle 27.

The dolly and trailer of the present invention provides many advantages over conventional watercraft trailer and support arrangements. For example, the trailer eliminates the need for separate trailers for utility and for moving of the watercraft. The trailer 30 can be utilized to both transport the watercraft, and can also be used as a “standard” utility trailer. Furthermore, the main support surface 34 of the trailer 30 is substantially larger than the watercraft, such that there is substantial space for transporting and/or storing additional items even when the watercraft is positioned on the trailer 30. Also, as discussed above, when the bunks 37 and 38 are lowered, they do not interfere when the trailer 30 is used as a utility trailer. The winch 53 on the trailer 30 ensures that a single person can load the watercraft onto the trailer 30. Similarly, the winch 20 on the dolly 1 ensures that an individual can easily load the watercraft from the trailer 30 to the dolly 1. This permits a single person to easily and quickly remove the watercraft from the trailer to permit use of the trailer for utility purposes. The dolly 1 is quite compacted, and requires less space than a conventional watercraft trailer. Accordingly, the watercraft can be stored in a garage or other area with limited space on the dolly 1 in a manner that would often not be possible on a standard watercraft trailer. Also, the dolly 1 can be readily maneuvered to different positions to permit an individual to work on the watercraft.

In the foregoing description, it will be readily appreciated by those skilled in the art that modifications may be made to the invention without departing from the concepts disclosed herein. Such modifications are to be considered as included in the following claims, unless these claims by their language expressly state otherwise.

1- A dolly for supporting watercraft, comprising:
a base frame having a plurality of wheels for movably supporting the base frame on a surface;
a pair of elongated parallel bunks fixed to the base frame, the bunks having upper surfaces adapted to support a watercraft on the dolly in a lowered position;
a support frame movably mounted to the base frame for vertical movement relative thereto, the support frame having a plurality of spaced apart rollers configured to movably support a watercraft;
a lift operably interconnected with the base frame and the support frame, the lift configured to move the support frame from a lower position wherein the rollers are at least about as low as the upper surfaces of the bunks, and a raised position wherein the rollers are substantially above the upper surfaces of the bunks.

2- The dolly of claim 1, wherein:
the support frame includes a pair of elongated structural members, each having a plurality of rollers configured to movably support a watercraft.

3- The dolly of claim 2, wherein:
the elongated structural members are positioned between the bunks.

4- The dolly of claim 1, including:
a winch secured to one of the base frame and the support frame for moving a watercraft on the dolly.

5- The dolly of claim 4, wherein:
the lift comprises a scissors jack including an elongated drive shaft rotatably supported by the base frame and a handle secured to the drive shaft for manual actuation of the scissors jack.

6- The dolly of claim 5, wherein:
the base frame includes a first upright frame member, the winch being mounted on an upper end of the first upright frame member, the base frame further including a pair of upright outer frame members and a horizontal frame member secured to the upright outer frame members above the winch to form a handle for manual transport of the dolly.

7- A trailer for transport of watercraft, comprising:
a frame including at least a pair of wheels and a tongue adapted to secure the trailer to a motor vehicle for transport of the trailer;
an enlarged horizontal main support surface secured to the frame, the main support surface having a pair of elongated openings therethrough;
first and second elongated bunks movably interconnected with the frame for movement between raised and lowered positions, the first and second bunk defining upper support surfaces that are positioned at about the same height as the main support surface when the bunks are in the lowered position;
first and second linkages movably interconnecting the bunks to the frame, the first and second linkages including a link having a first end pivotably connected to the frame, and a second end pivotably connected to first and second the bunks, respectively; and
retainers configured to secure the bunks in the raised positions.

8- The trailer of claim 7, wherein:
each retainer comprises a pin on a selected one of the bunkers and the main support surface, and an opening on the other of the bunkers and the main support surface.

9- The trailer of claim 7, wherein:
the support surface includes a retainer opening adjacent each elongated opening; and
each bunk includes a downwardly extending pin configured to engage the retainer openings to selectively secure the bunks in the raised position.

10- The trailer of claim 9, wherein:
the trailer defines a rear edge and includes a pair of rollers mounted to the frame on the rear edge positioned in alignment with the elongated openings.

11- The trailer of claim 10, including:
a center roller mounted to the frame between the pair of rollers.

12- The trailer of claim 11, wherein:
the main support surface defines a front edge and the frame includes an upwardly extending support adjacent the front edge; and including:
a winch mounted to the upwardly extending support above the main support surface.

13- A kit for supporting watercraft, comprising:
a dolly having a base frame with a plurality of wheels adapted to movably support the dolly on a surface, the dolly including a support frame having a plurality of rollers movably mounted to the base frame for movement between raised and lowered positions;
a trailer including a trailer frame and at least a pair of wheels to movably support the trailer on a surface and an enlarged horizontal main support surface, the trailer including a pair of elongated bunks defining upper support surfaces positioned above the main support surface; and wherein:
the rollers of the dolly are positioned at about the same height as the upper support surfaces of the bunks of the trailer when the support frame is in the raised position to facilitate transfer of a watercraft from the dolly onto the bunks of the trailer and vice versa.

14- The kit of claim 13, wherein:
the dolly includes a lift operably interconnected with the base frame and the support frame, the lift configured to move the support frame between the raised and lowered positions.

15- The kit of claim 14, wherein:
the lift comprises a scissors jack including an elongated drive shaft rotatably supported by the base frame and a handle secured to the drive shaft for manual actuation of the scissors jack.

16- The kit of claim 15, wherein:
the dolly includes a pair of elongated parallel bunks fixed to the base frame; and wherein:
the support frame includes a pair of elongated structural members, each having a plurality of rollers configured to movably support a watercraft.

17- The kit of claim 16, wherein:
the elongated structural members are positioned between the bunks.

18- The kit of claim 17, including:
a winch secured to one of the base frame and the support frame for moving a watercraft on the dolly.

19- The kit of claim 13, wherein:
the elongated bunks of the trailer are movable to a lower position at least about even with the main support surface.

20- The kit of claim 19, including:
a linkage movably interconnecting the elongated bunks of the trailer to the trailer frame for movement between upper and lower positions.

21- The kit of claim 20, including:
a retainer adapted to retain the bunks of the trailer in the upper position.
